(19) United States
(12) Patent Application Publication
(10) Pub. No.: US 2010/0262734 A1
(43) Pub. Date: Oct. 14, 2010

(54) WIRELESS USB DEVICE FOR NETWORKING WITH MULTIPLE WIRELESS USB HOSTS AND METHOD THEREOF

(76) Inventors: Jong-Moo Sohn, Daejon (KR); Jaedoo Huh, Daejon (KR)

Correspondence Address: STAAS & HALSEY LLP, SUITE 700, 1201 NEW YORK AVENUE, N.W., WASHINGTON, DC, 20005, US

(21) Appl. No.: 12/747,220

(22) PCT Filed: May 26, 2008
(86) PCT No.: PCT/KR08/02923

§ 371 Date: Jun. 10, 2010

(30) Foreign Application Priority Data
Dec. 11, 2007 (KR) 10-2007-0128376

(51) Int. Cl. G06F 13/20

(52) U.S. Cl. 710/107

(57) ABSTRACT

Provided are a Wireless USB device for networking with multiple Wireless USB hosts and a method thereof. The Wireless USB device includes a selection unit for selecting a device management unit which corresponds to a Wireless USB host based on MAS location information in the MAS allocation list, and relaying MMC frames to the selected device management unit; device management units for each Wireless USB host for analyzing MMC frames relayed from the selection unit, and performing a command defined in the MMC frames; and a common information storage for storing common information maintained and managed commonly to all Wireless USB hosts.

### TECHNICAL FIELD

The present invention relates to a Wireless USB device for networking with multiple Wireless USB hosts and a method thereof; and, more particularly, to a Wireless USB device for networking with multiple Wireless USB hosts which enables inter-networking among multiple Wireless USB clusters by individually processing association with each Wireless USB host, and a method thereof.

This work was supported by the IT R&D program for MIC/IITA [2007-S-047-01, “Development of HD Class Multimedia System Technology over Wireless Home Network”].

### BACKGROUND ART

A Universal Serial Bus (USB) is a successful interface standard which simplifies hardware and software in connection between Personal Computers (PC) and peripheral devices. USB has merits in support of the maximum physical transmission rate of 480 Mbps and the maximum number of 127 USB devices, and also in easy connection due to installation of unified hardware and software.

This USB technology has evolved to Wireless USB by applying WiMedia MAC/PHY standard based on multiband Orthogonal Frequency Division Multiplexing (OFDM) technology which is one of wireless communication technologies for Wireless Personal Area Network (WPAN). The first version of the Wireless USB standards has recently been completed and conforming initial chipsets and products are also introduced. Wireless USB has the same functions as a wired connection-based USB but differs in that things communicated wirelessly.

Since conventional wired USB maintains a strict host-device relationship, a single USB cluster, a USB network that includes one USB host and multiple USB devices, maintains a tree-shaped topology where multiple devices are connected to a single USB host like stems and leaves of a tree.

However, as the transmission medium is changed from a solid cable to a wireless medium in Wireless USB, the host and the devices now have a star-shaped topology.

FIG. 1 is a block diagram showing operations of a Wireless USB host and Wireless USB devices in a single conventional Wireless USB cluster.

As shown in FIG. 1, there are a single Wireless USB host 11 and more than one Wireless USB devices 12 in Wireless USB cluster.

The Wireless USB host 11 manages transmission/reception of all data through Micro-scheduled Management Command (MMC) with no regard to the topology or the communication medium. On the other hand, each Wireless USB device 12 performs an operation which is just a response to the commands in MMC from the host. Therefore, there is a limitation that no more than two Wireless USB hosts 11 can exist in a Wireless USB cluster 10 and Wireless USB cluster regions 10 cannot be overlapped.

This limitation does not generate a problem in a general case, i.e., a Wireless USB host, e.g., a PC 11, accesses more than one Wireless USB devices. However, when more than one Wireless USB hosts access a shared device such as a network printer, the connection rule between the single Wireless USB host and multiple Wireless USB devices acts as a limitation.

To overcome the mentioned limitation, when a Wireless USB cluster is formed with multiple PCs and a single printer, the printer and PCs should operate as a Wireless USB host and Wireless USB devices, respectively. However, when each PC operates as a Wireless USB device, another problem occurs that the PC cannot access to peripheral Wireless USB devices.

Although this limitation comes from the wire/Wireless USB standard, the internal structures in realization of Wireless USB devices also limit such an application. A general structure and operation of the conventional wired/Wireless USB device will be described with reference to FIG. 2 hereinafter.

FIG. 2 is a block diagram showing a conventional wired/Wireless USB device.

As shown in FIG. 2, conventional wired/Wireless USB devices include a beacon analyzer 21, an MMC manager 22, a Wireless USB database 23, an End-Point (EP) controller 24, and a device manager 25.

The beacon analyzer 21 receives and analyzes beacon frames transmitted from more than one Ultra Wide Band (UWB) communication devices, identifies Wireless USB hosts based on information of the analyzed beacon frames, associates with a Wireless USB host among the identified Wireless USB hosts, and extracts Media Access Slot (MAS) allocation information used by the Wireless USB host.

Also, when the beacon analyzer 21 receives a frame outside a beacon period, the beacon analyzer 21 determines whether the frame is transmitted from the associated Wireless USB host. If the frame is transmitted from the associated Wireless USB host, the beacon analyzer 21 relays received MMC frames to the MMC manager 22.

The MMC manager 22 extracts commands from the Wireless USB host by analyzing the MMC frames and performs the command using connection context between the Wireless USB host and the Wireless USB device, and diverse status information and configuration of the Wireless USB device with reference to the Wireless USB database 23.

Also, the MMC manager 22 enables the EP controller 24 so that an operation related to an End-Point (EP) of the Wireless USB device is performed by in the EP controller 24.

The Wireless USB database 23 stores description on each EP and status information of the Wireless USB device as well as connection context between the Wireless USB host and the Wireless USB device. In particular, when the Wireless USB host requests for direct management of the device status, the device manager 25 controls the status of the Wireless USB device based on the information stored in the Wireless USB database 23.

However, the explained conventional Wireless USB device has difficulty in identifying the commands from more than one Wireless USB hosts. Even if the conventional Wireless USB device identified the commands from more than one Wireless USB hosts, logically or physically independent command executioners, such as the MMC manager 22 and the EP controller 24, are required. Moreover, since the information related to the Wireless USB host and the Wireless USB device is stored in a single database, i.e., a Wireless USB database, multiple databases must be maintained so that each database manages the information of each host-device connection pair.

Differently from the conventional wired/Wireless USB host and devices, multiple hosts, e.g., a plurality of PCs can access the device, e.g., a network printer, through Ethernet because any host-device specific relation does not exist between multiple hosts and the device.

Therefore, in order to solve the above problem, not a method for realizing a conventional Wireless USB cluster including a single host and multiple devices, but a method for realizing a Wireless USB cluster including multiple hosts and a single device is required. Also, a method for enabling the single Wireless USB device to simultaneously be included in more than one Wireless USB cluster to maintain/manage association with multiple Wireless USB hosts is required.

### DISCLOSURE

### Technical Problem

An embodiment of the present invention is directed to providing a wireless Universal Serial Bus (USB) device for networking with multiple Wireless USB hosts which enables inter-networking among multiple Wireless USB clusters by individually processing association with each Wireless USB host, and a method thereof.

The objects of the present invention are not limited to the above-mentioned ones. Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, a wireless Universal Serial Bus (USB) device, including: a selection unit for selecting a device management unit which corresponds to a Wireless USB host based on MAS location information in the MAS allocation list, and relaying MMC frames to the selected device management unit; device management units for each Wireless USB host for analyzing MMC frames relayed from the selection unit, and performing a command defined in the MMC frames; and a common information storage for storing common information maintained and managed commonly to all Wireless USB hosts.

In accordance with another aspect of the present invention, a method for networking, including: analyzing contents of beacon frames and creating a MAS allocation list which lists MAS allocation information for each Wireless USB host; receiving MMC frames from each Wireless USB host and calculating a MAS location where the MMC frame is received; selecting a device management unit which corresponds to a Wireless USB host based on the created MAS allocation list and relaying received MMC frame to the selected unit; and analyzing MMC frames relayed from the selection unit, and performing a command defined in the MMC frames.

### ADVANTAGEOUS EFFECTS

As described above, since the present invention provides a networking method with multiple wireless Universal Serial Bus (USB) hosts by individually processing association with each Wireless USB host, multiple preexisting Wireless USB clusters can easily be combined or overlapped without any reformation.

Since multiple Wireless USB hosts share a single Wireless USB device at the same time, the present invention can extend an application field of the Wireless USB device.

Also, in the present invention, data can be transmitted/received between the Wireless USB hosts through data relaying in a Wireless USB device.

### BRIEF DESCRIPTION OF THE DRAWINGS

FIG. 1 is a block diagram showing operations of a Wireless USB host and Wireless USB devices in a single conventional Wireless USB cluster.

FIG. 2 is a block diagram showing a conventional wired/Wireless USB device.

FIG. 3 is a block diagram showing an operation of the Wireless USB device in accordance with an embodiment of the present invention.

FIG. 4 is a block diagram showing the Wireless USB device for networking with multiple Wireless USB hosts in accordance with an embodiment of the present invention.

FIG. 5 is a flowchart describing a method for networking with Wireless USB hosts in accordance with an embodiment of the present invention.

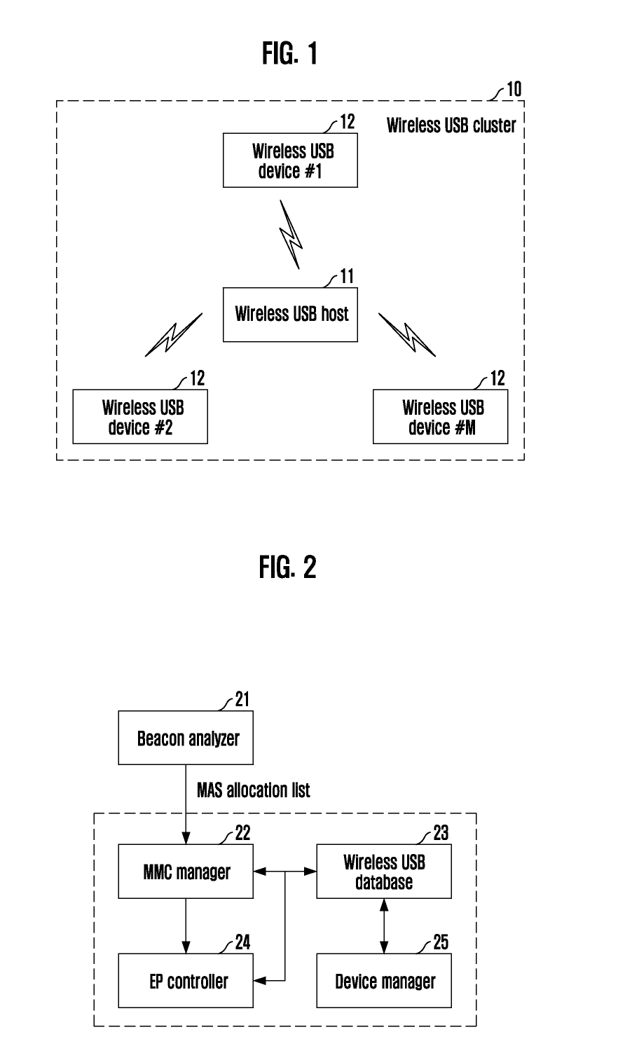

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

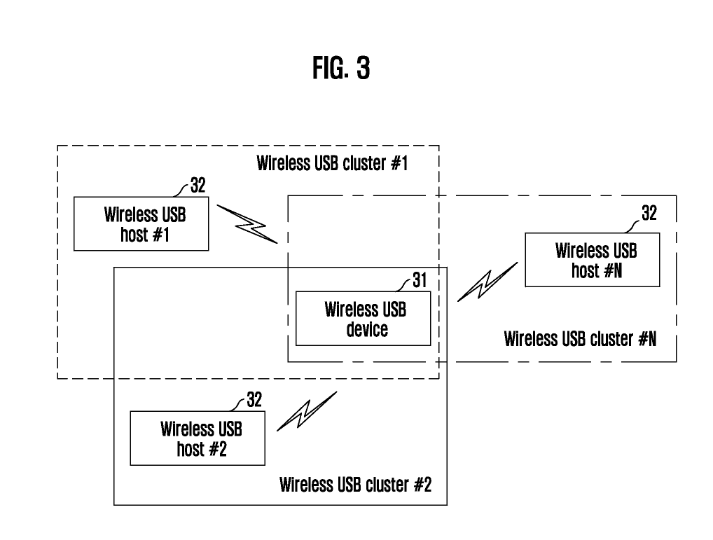

FIG. 3 is a block diagram showing an operation of the Wireless USB device in accordance with an embodiment of the present invention.

Referring to FIG. 3, a Wireless USB device 31 in accordance with the present invention can simultaneously have access to Wireless USB hosts 32 in different Wireless USB clusters. To be specific, the single Wireless USB device 31 in accordance with the present invention simultaneously included in more than one Wireless USB clusters maintains and manages association with Wireless USB hosts 32 and performs mutual communication.

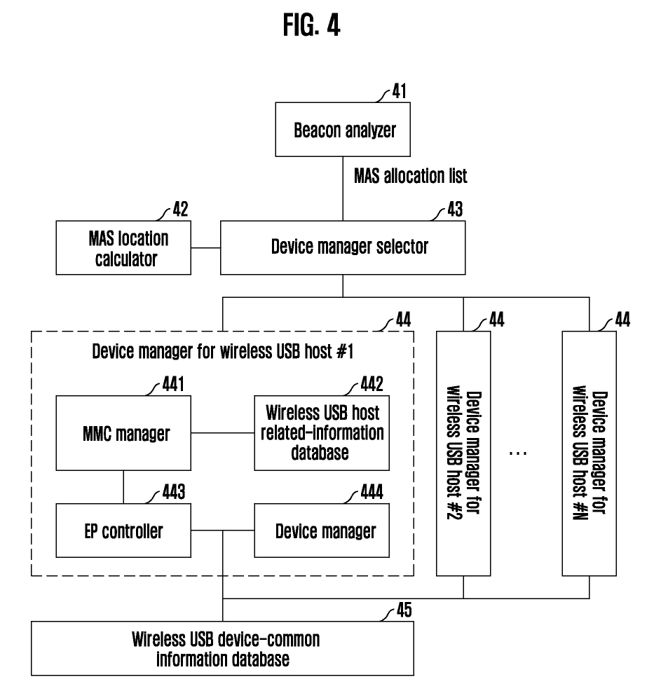

Detailed constituent elements of the Wireless USB device 31 will be described with reference to FIG. 4.

FIG. 4 is a block diagram showing the Wireless USB device for networking with multiple Wireless USB hosts in accordance with an embodiment of the present invention.

Referring to FIG. 4, the Wireless USB device includes a beacon analyzer 41, a Media Access Slot (MAS) location calculator 42, a device manager selector 43, device managers for each Wireless USB host 44, and a Wireless USB device-common information database 45, which is called a common information database hereinafter.

The beacon analyzer 41 creates a list of ‘WiMedia’ UWB devices, e.g., the Wireless USB hosts, by analyzing beacon frames from the ‘WiMedia’ UWB devices, and extracts allocated MAS that each Wireless USB host has reserved for its own usage.

Also, the beacon analyzer 41 creates a MAS allocation list that adds MAS allocation information of each Wireless USB host to the created WiMedia USB host list.

The MAS allocation list uses a source address extracted from the beacon frame as a representative value of the Wireless USB host, and stores MAS allocation information that each Wireless USB host reserved in a bitmap format, and also stores the index of device manager 44 that corresponds to the Wireless USB host.

When the MAS location calculator 42 receives a Micro-scheduled Management Command (MMC) frame from the Wireless USB host in the MAS section reserved by the Wireless USB hosts enlisted by the beacon analyzer 41, the MAS location calculator 42 calculates the received MAS. That is, the MAS location calculator 42 calculates the time of receception of all frames from the Wireless USB host in MAS basis.

The device manager selector 43 identifies the address of the Wireless USB host which transmits the MMC frame based on the MAS location information calculated by the MAS location calculator 42 and the MAS allocation list created by the beacon analyzer 41, and selects the device manager for host 44 that corresponds to the Wireless USB host which transmits the MMC frame.

When there is no corresponding device manager for host 44 for the source Wireless USB host of the received MMC frame, the device manager selector 43 selects any one of the device managers for host 44 which is not yet assigned, and relays the MMC frame from the Wireless USB host to the selected device manager for host 44.

When there is no corresponding device manager for host 44 for the source Wireless USB host of the received MMC frame and all device managers for host 44 are already assigned, the device manager selector 43 simply discards the received MMC frame.

When there is a corresponding device manager for host 44 for the source Wireless USB host of the received MMC frame, the device manager selector 43 activates the device manager for host 44 and relays the received MMC frame to the activated device manager for host 44.

When the device manager selector 43 receives association setup information with the Wireless USB host from the device manager for host 44, the device manager selector 43 registers the index of the device manager for host 44 which corresponds to the Wireless USB host in the MAS allocation list created by the beacon analyzer 41 and enables the corresponding device manager for host 44.

When the device manager selector 43 receives association release information from the device manager for host 44, the device manager selector 43 unregisters the index of the device manager for host 44 in the MAS allocation list created by the beacon analyzer 41 and disables the corresponding device manager for host 44.

The device manager for host 44 analyzes the MMC frame relayed from the device manager selector 43 and performs a command defined in the MMC frame. The command defined in the MMC frame includes association setup, association release, and general data transmission/reception.

Here, the number of the device managers for host 44 is the same as the number of the Wireless USB hosts which can be simultaneously associated with the Wireless USB device. Only one corresponding device manager for host 44 for the source Wireless USB host of the received MMC frame is activated in certain MAS.

The device manager for host 44 includes an MMC manager 441, a Wireless USB database 442 which contains host related-information, an EP controller 443, and a device manager 444.

The MMC manager 441 analyzes the MMC frame from the device manager selector 43, parses the command defined in the MMC frame, and performs the command.

Also, when the association with a Wireless USB host is set up, the MMC manager 441 manages association with the Wireless USB host by registering an address of the Wireless USB host transmitting the MMC frame, validity of MAS allocation information and the connection context in the Wireless USB database 442. Subsequently, the MMC manager 441 sends association setup information, i.e., information that association with the Wireless USB host is set up, to the device manager selector 43. Herein, the connection context is required for association and cooperation with the Wireless USB host.

When the association with the Wireless USB host is released, the MMC manager 441 deletes the Wireless USB host specific information in the Wireless USB database 442, and sends association release information, i.e., information that association with the Wireless USB host is released, to the device manager selector 43.

The release of association between the device manager for host 44 and the Wireless USB host may occur when the association set up procedure between the Wireless USB host and the device manager for host 44 fails, or when an association release command from the Wireless USB host is executed by the device manager for host 44.

The Wireless USB database 442 stores a connection context required for association and cooperation with the Wireless USB host. The connection context includes an address of the source Wireless USB host of the received MMC frame registered by the MMC manager 441, MAS allocation and validity information.

The EP controller 443 performs an operation related to the End-Point (EP) of the Wireless USB device among the commands analyzed by the MMC manager 441. That is, the EP controller 443 handles data transmission/reception within the effective transaction period defined by the MMC frame.

The EP controller 443 shares EPs that physically exist in the Wireless USB device. As an example of a sharing method, when the Wireless USB device has bulk EP IN/OUT points and the EP controller 443 is to use the bulk EP IN, the EP controller 443 may use an actual EP IN only after checking that the EP controllers 443 in other device managers 44 does not use the EP IN. Subsequently, the EP controller 443 marks the usage of the physical EP by marking in the common information database 45. When the operation of the EP controller 443 on the EP IN is completed, the mark in the common information database 45 is removed so that EP controllers 443 of other device managers 44 can use the EP IN.

The device manager 444 controls the entire state of the Wireless USB device based on the information in the common information database 45.

The common information database 45 stores common information that the Wireless USB device maintains and manages for all Wireless USB hosts in common, e.g., device descriptors, EP descriptors, device status, port status, and power status.

As an example of using the common information database 45, when each Wireless USB host is to acquire information of the Wireless USB device, the device managers for host 44 which corresponds to each Wireless USB host reads the contents stored in the common information database 45 and transmits the contents to the Wireless USB hosts.

As another example of using the common information database 45, when each Wireless USB host is to control power status of the Wireless USB device, the device managers for host 44 which corresponds to the Wireless USB host that wishes to control power status of the device instantly acknowledges the power control command from the Wireless USB host and registers the status value in the common information database 45. Subsequently, the device manager for host 44 checks the common information database 45 and then performs the power status change operation when all device managers for host 44 have already registered the same power status value in the common information database 45. As described above, because the response to the power status change command is separated from the actual state change operation, more than one Wireless USB host can change the state of the single Wireless USB device without any collision.

An example of a networking procedure between the Wireless USB hosts each in its own Wireless USB cluster through the Wireless USB device will be described.

The actual EPs of the Wireless USB device perform Ethernet-over-USB function just as in Linux operating system, and route Ethernet frames from the device managers for host 44. The device managers for host 44 fools Wireless USB hosts so that the device is recognized as a network interface, and assigns different Ethernet Media Access Control (MAC) addresses for each Wireless USB host such that Ethernet frames from each Wireless USB host can be distinguished.

The data each Wireless USB host transmits using Ethernet-over-USB mechanism are transformed into Ethernet frames in the EPs of the Wireless USB device. The Ethernet frames are routed based on the Ethernet MAC addresses that are all set differently for each Wireless USB host, transformed back into the USB format, and then transmitted to the destined Wireless USB host.

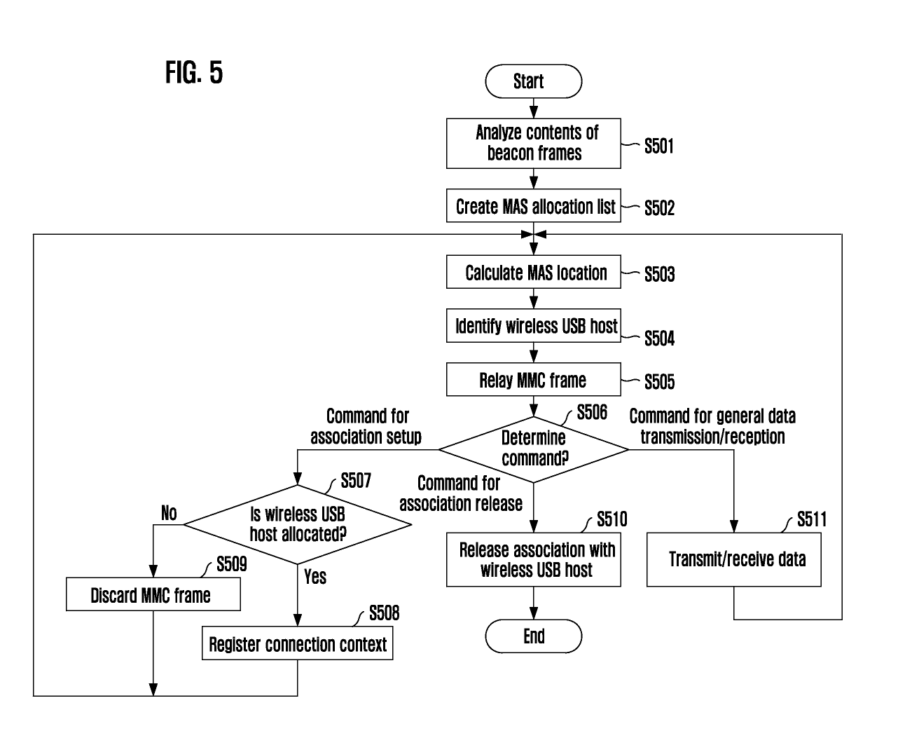

FIG. 5 is a flowchart describing a method for networking with the Wireless USB hosts in accordance with an embodiment of the present invention.

The beacon analyzer 41 analyzes contents of beacon frames from ‘WiMedia’ UWB devices at step S501, and creates MAS allocation list at step S502 by mapping ‘WiMedia’ UWB devices, especially Wireless USB hosts, with MAS allocation reserved by each ‘WiMedia’ UWB devices.

Since each UWB device uses exclusive MAS section, the UWB device, especially the Wireless USB host, can be easily identified with the MAS number by searching through the MAS allocation list.

As an example, an entry of the MAS allocation list may be expressed as a combination of the hexadecimal source address of the beacon frames and the MAS allocation information expressed in a bitmap format.

When the MAS location calculator 42 receives an MMC frame from a Wireless USB host, the MAS location calculator 42 calculates the MAS location where the MMC frame is received at step S503.

The device manager selector 43 identifies the Wireless USB host transmitting the MMC frame based on the calculated MAS location and the created MAS allocation list at step S504, selects a device manager for host 44 which corresponds to the Wireless USB host which transmits the MMC frame, and relays the MMC frame to the selected device manager for host 44 at step S505.

When there is no device manager for host 44 that corresponds to the Wireless USB host, the device manager selector 43 selects any one of the unused device managers for host 44 temporally, and relays the MMC frame from the Wireless USB host to the selected device manager for host 44.

When there is no device manager for host 44 that corresponds to the Wireless USB host and all device managers for host 44 are in use, the device manager selector 43 discards the MMC frame and the logic flow goes to the step S503 to wait for the next MMC frame.

When there is the device manager for host 44 that corresponds to the Wireless USB host, the device manager selector 43 activates the device manager for host 44 and relays the received MMC frame to the activated device manager for host 44.

The device manager for host 44 selected by the device manager selector 43 analyzes the MMC frame from the device manager selector 43, and determines whether the command defined in the MMC frame is for association setup, association release, or data transmission/reception at step S506.

When it turns out at the step S506 that the command defined in the MMC frame is for association setup, the device manager for host 44 checks at step S507 whether the Wireless USB host can be allocated.

That is, the device manager for host 44 analyzes the MMC frame at the step S506, and determines whether to permanently assign the device manager for host 44 to the Wireless USB host or not, according to the analysis result.

When it turns out at step S507 that the device manager for host 44 can assign the Wireless USB host, the device manager for host 44 sets up permanent association with the Wireless USB host, and registers connection context required for association and cooperation with the Wireless USB host, which includes an address of the Wireless USB host, MAS allocation and validity information at step S508.

The device manager for host 44 sends information that association with the Wireless USB host is set up to the device manager selector 43 so that the device manager selector 43 can finally link the device manager for host 44 to the Wireless USB host. The logic flow goes to the step S503 to wait for the next MMC frame.

When it turns out at the step S507 that the device manager for host 44 cannot assign the Wireless USB host, the device manager for host 44 discards the MMC frame at step S509 and the logic flow goes to the step S503 to wait for the next MMC frame.

When it turns out at step S506 that the command defined in the MMC frame is for association release, the device manager for host 44 releases the association with the Wireless USB host and permanently deletes the connection context for the Wireless USB host at step S510.

The device manager for host 44 sends the information that association with the Wireless USB host is released to the device manager selector 43 so that the device manager selector 43 can remove the link between the device manager for host 44 and the Wireless USB host.

When it turns out at the step S506 that the command defined in the MMC frame is for data transmission/reception, the device manager for host 44 performs data transmission/reception following to the command at step S511, and the logic flow goes to the step S503 to wait for the next MMC frame.

Since FIG. 5 shows an example of the networking method between the Wireless USB device and the Wireless USB hosts, the present invention is not limited to networking with the single Wireless USB host described above, and networking with more than one Wireless USB host is possible.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

The present application contains subject matter related to Korean Patent Application No. 2007-0128376, filed in the Korean Intellectual Property Office on Dec. 11, 2007, the entire contents of which are incorporated herein by reference.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The present invention can be applied to the wireless Universal Serial Bus (USB) system.

What is claimed is:

1. A wireless Universal Serial Bus (USB) device, comprising:
a selection means for selecting a device management means for host which corresponds to a Wireless USB host based on Media Access Slot (MAS) location information in the MAS allocation list, and relaying MMC frames to the selected device management unit;
the device management means for each Wireless USB host for analyzing MMC frames relayed from the selection means and performing a command defined in the MMC frames; and
a common information storage for storing common information maintained and managed commonly to all Wireless USB hosts.

2. The device of claim 1, wherein the selection means includes:
a beacon analyzer for analyzing beacon frames, extracting a MAS section of each Wireless USB host, and creating a MAS allocation list;
a MAS location calculator for calculating the MAS location of the received MMC frame from each Wireless USB host; and
an MMC frame relay for selecting the device management means which corresponds to the Wireless USB host based on MAS location information calculated by the MAS location calculator and the MAS allocation list created by the beacon analyzer, and relaying the MMC frame.

3. The device of claim 2, wherein the number of the device managements means for host is the same as the number of the Wireless USB host which can be simultaneously associated with the Wireless USB device.

4. The device of claim 3, wherein the device management means for host includes:
an MMC manager for analyzing the MMC frame transmitted from the MMC frame transmitter, and registering and deleting the connection context for the Wireless USB host associated with the MMC manager;
a Wireless USB database for storing and deleting the connection context for the Wireless USB host by the MMC manager;
an End-Point (EP) controller for executing EP-related commands from the MMC manager; and
a device manager for controlling the entire state of the Wireless USB device with reference to common information stored in the common information database means.

5. The device of claim 4, wherein the MMC manager relays association setup information to the MMC frame transmitter when association with the Wireless USB host is set up, and the MMC manager relays association release information to the MMC frame transmitter when the association is released.

6. The device of claim 5, wherein the association release information is generated when association between the Wireless USB host and the device management means for host fails, or when a command for association release is received from the Wireless USB host.

7. The device of claim 4, wherein the connection context is required for association and cooperation with the Wireless USB host and includes an address of the Wireless USB host, MAS allocation and validity information.

8. The device of claim 2, wherein the MMC frame transmitter registers the index of selected device management means for host which corresponds to the Wireless USB host in the MAS allocation list created by the beacon analyzer when the association setup is requested, and deletes the index of selected device management means for host when the association release request is received.

9. The device of claim 2, wherein the MAS allocation list uses each source address extracted from the beacon frame as a representative value of each Wireless USB host, stores MAS allocation information reserved by each Wireless USB host in a bitmap format, and stores the index of the device management means for host which corresponds to each Wireless USB host.

10. The device of claim 2, wherein the MMC frame transmitter relays the MMC frame to any unused device management means for host when there is no device management means for host which is assigned to the Wireless USB host, discards the MMC frame when there is no device management means for host which is assigned to the Wireless USB host and all device management means for host are in use, and activates the device management means for host and relays the MMC frame when there is the device managing means for host which is already assigned to the Wireless USB host.

11. The device of claim 2, wherein the common information includes at least one of device descriptor information, EP descriptor information, device status information, port status information, and power status information of the device.

12. A method for networking in a wireless Universal Serial Bus (USB) device, comprising:
analyzing contents of beacon frames, and creating a MAS allocation list by mapping WiMedia UWB devices with MAS allocation reserved by each devices;
calculating a MAS location of the received MMC frame from each Wireless USB host;
selecting a device manager for host which corresponds to the Wireless USB host based on the created MAS allocation list and the calculated MAS location information and relaying the MMC frame to the selected device manager for host; and
performing the command by receiving and analyzing the MMC frame in the selected device manager for host.

13. The method of claim 12, wherein the command is performed independently to each Wireless USB host.

14. The method of claim 13, wherein the said performing the command includes:
when the command for association setup, determining whether to permanently link the device manager to the Wireless USB host, and registering connection context for the Wireless USB host if it is determined to link the device manager to the Wireless USB host;
discarding the received MMC if it is determined not to permanently link the device manager to the Wireless USB host;
when the command for association release, releasing association with the Wireless USB host;
when the command for general data transmission and reception, transmitting and receiving the data.

15. The method of claim 14, wherein the connection context is required for association and cooperation with the Wireless USB host and includes an address of the Wireless USB host, MAS allocation and validity information.

16. The method of claim 12, wherein the MAS allocation list uses each source address extracted from the beacon frames as a representative value of each Wireless USB host, stores MAS allocation information reserved by each Wireless USB host in a bitmap format, and stores the index of the device manager for host which corresponds to each Wireless USB host.
